(19) United States
(12) Patent Application Publication
(10) Pub. No.: US 2023/0220713 A1
(43) Pub. Date: Jul. 13, 2023

(54) DRIVEN SPRING SYSTEM FOR HOOD

(71) Applicant: Magna Closures Inc., Newmarket (CA)

(72) Inventors: Vladimir Lebsak, Wuppertal (DE); Michael Digel, Wuppertal (DE); Wolfgang Millahn, Hilden (DE); Andreas Tesch, Wuppertal (DE)

(21) Appl. No.: 18/153,747

(22) Filed: Jan. 12, 2023

Related U.S. Application Data
(60) Provisional application No. 63/298,682, filed on Jan. 12, 2022.
(60) Provisional application No. 63/302,825, filed on Jan. 25, 2022.

(51) Int. Cl. E05F 3/00; E05F 1/10

(52) U.S. Cl. CPC E05F 3/00; E05F 1/105; E05Y 2201/21; E05Y 2201/232; E05Y 2201/266; E05Y 2201/474; E05Y 2201/484; E05Y 2201/638; E05Y 2201/626; E05Y 2201/668; E05Y 2201/654; E05Y 2900/536

(57) ABSTRACT

A spring driven system for moderating an opening speed of a closure panel of a vehicle, the system comprising: a pop up mechanism mounted adjacent to the closure panel for moving the closure panel from a fully closed position to a partially open position, the pop up mechanism having a plunger; and a biased cam mechanism coupled to the pop up mechanism by a coupling, the biased cam mechanism having a biasing element for moderating a deployment rate of the plunger.

### CROSS-REFERENCE TO RELATED APPLICATIONS

This application claims priority from the benefit of the filing date of U.S. Provisional Patent Application No. 63/298,682 filed on Jan. 12, 2022, entitled “HINGE BASED DETENT MECHANISM” and U.S. Provisional Patent Application No. 63/302,825 filed on Jan. 25, 2022, entitled “DRIVEN SPRING SYSTEM FOR HOOD”, the contents of which are herein incorporated by reference.

### FIELD

This disclosure relates to pop up mechanisms for a closure panel and hinge based open and close mechanisms for a closure panel.

### BACKGROUND

Vehicles are equipped with compartment (e.g. engine bay) closure panels, with associated pop up mechanisms. Unfortunately, especially for higher end vehicles the pop up mechanism in operation is typically abrupt and noisy. In particular, rapid pop up hoods are encountered with larger vehicles.

As such, it is needed to have a way to reduce the rate of pop up while also being able to provide for a safe and expected operation of the pop up mechanism in a variety of situations (e.g. open and close operations of the hood).

Some vehicles are equipped with a closure panel, such as a lift gate, which is driven between an open position (position 2) and a closed position (position 1) using an electrically driven lift or opening system. Disadvantages of the current systems include the fact that the doors can be opened at larger angles, such as 180 to 270 degrees. Due to these large open angles, the doors can arbitrarily rest (e.g. stop) in any position based on a number of factors, including the position of the vehicle (e.g. parking on a steep road) as well as environmental conditions (e.g. strong winds buffeting the vehicle).

As such, it is needed to have a way to temporarily lock the closure panel in a selected (e.g. predefined) position in order to make the closure panel positioning more resistant to windy conditions and/or steep parking conditions.

Current closure panel detent designs include rod—cylinder arrangements (pneumatic, hydraulic or other) in order to selectively cause friction on the rod to thereby block or at least brake operation of the hinge (e.g. DE 10 2009 053 938). Another current dent design is described in DE 10 2008 047 952 by ISE Automotive, which provides a detent sleeve having detent marks which arrest hinge movement with detent elements driven by motion of the door. However, these existing designs can be positioned exterior to the hinge mechanism itself and thus can cause issues with respect to form factors and general operational constraints. Further, having set detent positions can be disadvantageous, especially in hinge setups needing more flexibility in selection of the desired detent angles (ultimately the angle the door makes with the vehicle body when placed in an open position).

Further, bulky form factors which take up valuable vehicle cargo space, for example, occupying space along the vertical supports delimiting the opening of a rear liftgate. As such, the current detent systems can undesirably limit the size of access through the opening and into the interior cargo space, require additional lift support systems in tandem such as gas struts and other counterbalance mechanisms, have an unacceptable impact on manual open and close efforts requiring larger operator applied manual force at the panel handle, and/or temperature effects resulting in variable manual efforts required by the operator due to fluctuations in ambient temperature.

### SUMMARY

It is an object of the present invention to provide a spring based system for a hood that obviates or mitigates at least one of the above presented disadvantages.

One aspect provided is a spring driven system for moderating an opening speed of a closure panel of a vehicle, the system comprising: a pop up mechanism mounted adjacent to the closure panel for moving the closure panel from a fully closed position to a partially open position, the pop up mechanism having a plunger; and a biased cam mechanism coupled to the pop up mechanism by a coupling, the biased cam mechanism having a biasing element for moderating a deployment rate of the plunger.

A second aspect provided is a method for moderating an opening speed of a closure panel of a vehicle employing a pop up mechanism, the method comprising the steps of: coupling a biased cam mechanism to the pop up mechanism by a coupling; engaging a biasing element of the biased cam mechanism to the movement of the coupling in order to moderate a deployment rate of the plunger.

A third aspect provided is a biased cam mechanism for coupling by a coupling to a pop up mechanism used by a closure panel of a vehicle, the biased cam mechanism having a biasing element for moderating a deployment rate of a plunger of the pop up mechanism by engaging with a cam spring element.

Another aspect is a spring driven system for moderating an opening speed of a closure panel of a vehicle, the system includes a pop up mechanism mounted adjacent to the closure panel for moving the closure panel from a fully closed position to a partially open position, the pop up mechanism, and an actuator operably coupled to the pop up mechanism, the actuator adapted to moderate the speed of the closure panel moving from the fully closed position to the partially open position.

Other aspects, including methods of operation, and other embodiments of the above aspects will be evident based on the following description and drawings.

It is an object of the present invention to provide a hinge based detent mechanism that obviates or mitigates at least one of the above presented disadvantages.

One further aspect provided is a hinge having a detent function for a closure panel of a vehicle, the hinge having: a plurality linkages connecting the closure panel to a vehicle body for guiding movement of the closure panel relative to the vehicle body between an open position and a closed position; and a detent mechanism connected to a pair of the plurality of linkages for resisting motion of the hinge, the detent mechanism including a detent element.

A further aspect provided is a method for positioning a closure panel of a vehicle at a predefined detent position between an open position and a closed position of the closure panel, the method comprising the steps of: providing a plurality linkages connecting the closure panel to a vehicle body for guiding movement of the closure panel relative to the vehicle body between the open position and the closed position; and operating a detent mechanism connected to a pair of the plurality of linkages for resisting motion of the hinge during operation of the hinge, the detent mechanism including a detent element.

Further aspects provided are: the plurality of linkages includes a door portion of the hinge used to connect the hinge to the closure panel and a body portion of the hinge used to connect the hinge to the body; wherein the plurality of linkages are coupled to one another by a plurality of respective pivots; the detent mechanism including a first additional element and a second additional element, such that the detent mechanism is coupled to the plurality of linkages by a pair of corresponding pivot points; wherein the detent element is positioned on at least one pivot point of the pair of pivot points; the detent mechanism including a third pivot point coupling the first additional element to the second additional element; wherein the detent element is positioned on the third pivot point; wherein the plurality of linkages is provided as a four bar linkage including a body portion of the hinge and a door portion of the hinge; wherein the pair of linkages includes one of a body portion of the hinge and a door portion of the hinge and a linkage connecting the body portion to the door portion.

### BRIEF DESCRIPTION OF THE DRAWINGS

Reference is made, by way of example only, to the attached figures, wherein:

FIG. 1 is a side view of a vehicle with one or more closure panels;

FIG. 2 is a front perspective view of a vehicle with one or more closure panels illustrating a driven spring system of FIG. 1;

FIG. 3 is a side view of the spring system of FIGS. 1 and 2;

FIG. 4 shows a first operation of the spring system of FIGS. 1 and 2;

FIG. 5 shows an enlarged view of a portion of the system of FIG. 4;

FIG. 6 shows a second operation of the spring system of FIGS. 1 and 2;

FIG. 7 shows an enlarged view of a portion of the system of FIG. 6;

FIG. 8 shows a third operation of the spring system of FIGS. 1 and 2;

FIG. 9 shows a fourth operation of the spring system of FIGS. 1 and 2;

FIG. 10 shows a fifth operation of the spring system of FIGS. 1 and 2;

FIG. 10a shows an enlarged view of a portion of the system of FIG. 10;

FIG. 11 shows a sixth operation of the spring system of FIGS. 1 and 2;

FIG. 11a shows an enlarged view of a portion of the system of FIG. 11;

FIG. 12 shows a seventh operation of the spring system of FIGS. 1 and 2;

FIG. 13 shows a eight operation of the spring system of FIGS. 1 and 2;

FIG. 14 shows a ninth operation of the spring system of FIGS. 1 and 2;

FIGS. 15A, 15B, 15C show example operations of a latching system for the spring system of FIGS. 1 and 2;

FIG. 16 shows an example operation of the spring driven system of FIGS. 1 and 2;

FIG. 17 is a side view of a vehicle with one or more closure panels;

FIG. 18 is a rear perspective view of a vehicle with one or more closure panels illustrating the hinge based detent mechanism positioned along a hinge axis;

FIG. 19 is an alternative embodiment of the vehicle of FIG. 17;

FIG. 20 is an alternative embodiment of the vehicle of FIG. 17;

FIG. 21 shows a plan view of an embodiment of the hinge based detent mechanism of FIGS. 17, 18, 19;

FIG. 22 shows a schematic diagram of a plurality of linkages of the hinge of FIG. 21;

FIGS. 23, 24, 25, and 26 show different embodiments of a position of a detent element of the detent mechanism of the hinge of FIG. 17, 18, 19;

FIGS. 27, 28 show different operational positions of the hinge of FIGS. 17, 18, 19;

FIGS. 29, 30, 31 shows one embodiment of the detent element of FIGS. 23-26; and

FIG. 32 shows a further embodiment of the detent element of FIGS. 6-9.

### DETAILED DESCRIPTION OF EXAMPLE EMBODIMENTS

In this specification and in the claims, the use of the article “a”, “an”, or “the” in reference to an item is not intended to exclude the possibility of including a plurality of the item in some embodiments. It will be apparent to one skilled in the art in at least some instances in this specification and the attached claims that it would be possible to include a plurality of the item in at least some embodiments. Likewise, use of a plural form in reference to an item is not intended to exclude the possibility of including one of the item in some embodiments. It will be apparent to one skilled in the art in at least some instances in this specification and the attached claims that it would be possible to include one of the item in at least some embodiments.

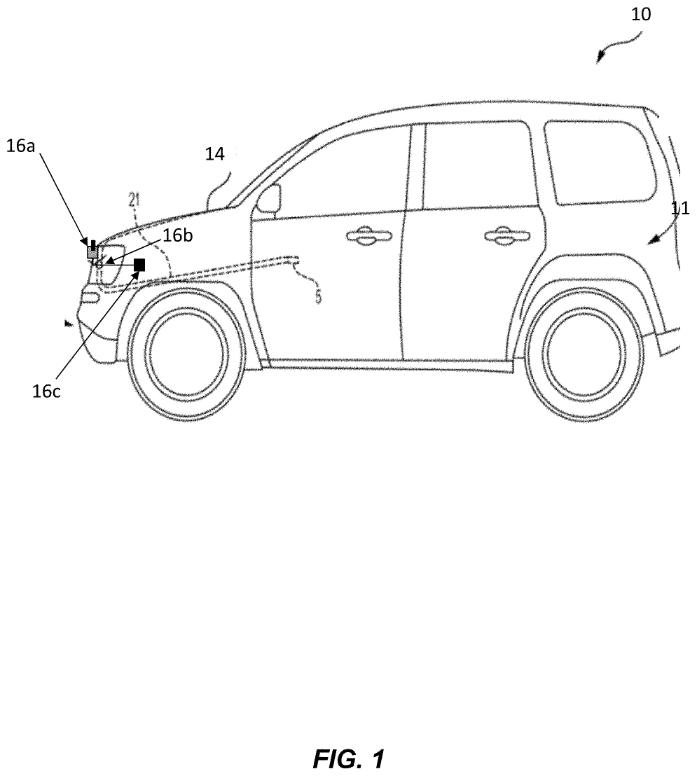

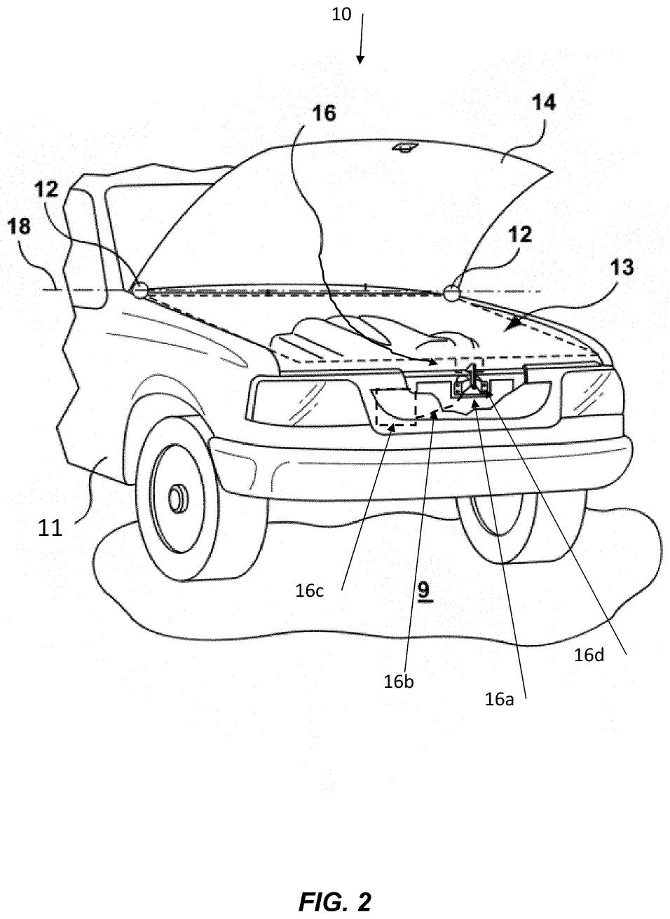

Referring again to FIGS. 1 and 2, shown is a vehicle 10 with a vehicle body 11 having one or more closure panels 14. For vehicles 10, the closure panel 14 can be referred to as a partition or door, typically hinged, but sometimes attached by other mechanisms such as tracks, in front of an opening 13 which is used for entering and exiting the vehicle 10 interior by people and/or cargo. It is also recognized that the closure panel 14 can be used as an access panel for vehicle 10 systems such as engine compartments (see FIG. 2) and also for traditional trunk compartments of automotive type vehicles 10. The closure panel 14 can be opened to provide access to the opening 13, or closed to secure or otherwise restrict access to the opening 13. For example decklids, frunks, hoods, tailgates. A frunk is also known as a front trunk provided as a storage compartment for user items such as luggage and groceries. Whereas the front compartment space of vehicles has been traditionally occupied by an engine, frunks are provided in electric vehicles, or with vehicles having the engine mounted in the rear of the vehicle. Also closure panel 14 can be for a center console with hinged lid configuration, glove compartments, pickup truck covers, windows and the like.

The closure panel 14 can be opened manually and/or powered electronically, where powered closure panels 14 can be found on minivans, high-end cars, or sport utility vehicles (SUVs) and the like. Additionally, one characteristic of the closure panel 14 is that due to the weight of materials used in manufacture of the closure panel 14, some form of force assisted open and close mechanism (or mechanisms) are used to facilitate operation of the open and close operation by an operator (e.g. vehicle driver) of the closure panel 14.

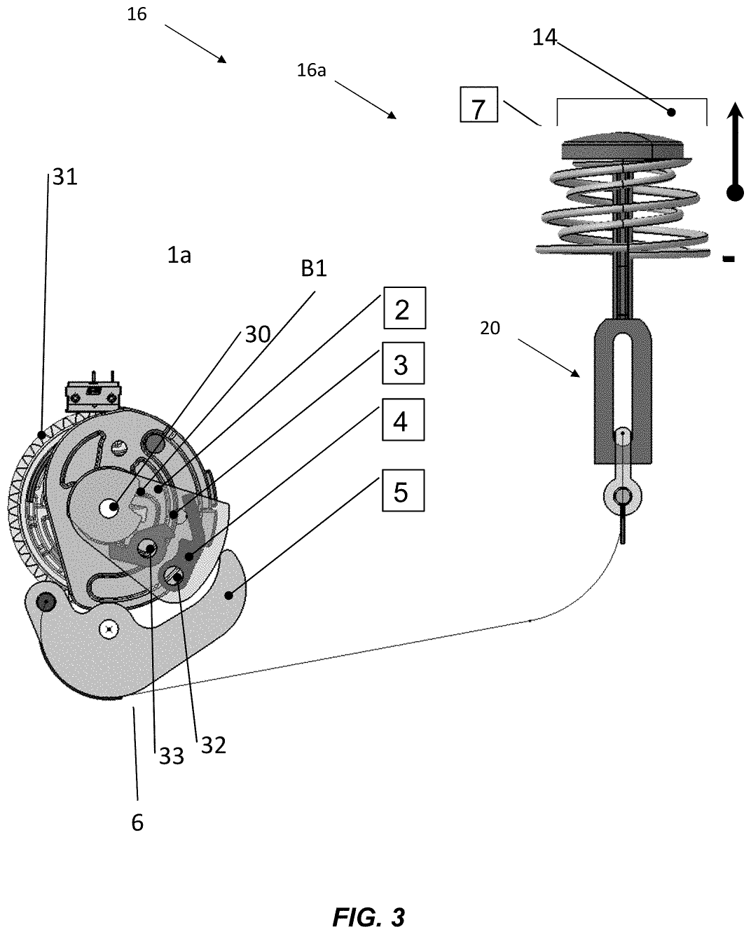

In terms of vehicles 10, the closure panel 14 may be a hood as shown in FIGS. 1 and 2, or it may be some other kind of closure panel 14, such as a lift gate, an upward-swinging vehicle door (i.e. what is sometimes referred to as a gull-wing door) or a conventional type of door that is hinged at a front-facing or back-facing edge of the door (see FIG. 3), and so allows the door to swing (or slide) away from (or towards) the opening 13 in the body 11 of the vehicle 10. Canopy doors are a type of door that sits on top of the vehicle 10 and lifts up in some way, to provide access for vehicle passengers via the opening 13 (e.g. car canopy, aircraft canopy, etc.). Canopy doors can be connected (e.g. hinged at a defined pivot axis and/or connected for travel along a track) to the body 11 of the vehicle at the front, side or back of the door, as the application permits.

Referring again to FIG. 2, in the context of a vehicle application of a closure panel by example only, the closure panel 14 is movable between a closed position (shown in dashed outline) and an open position (shown in solid outline). In the embodiment shown, the closure panel 14 pivots between the open position and the closed position about a pivot axis 18, which can be configured as horizontal or otherwise parallel to a support surface 9 of the vehicle 10. In other embodiments, the pivot axis 18 may have some other orientation such as vertical or otherwise extending at an angle outwards from the support surface 9 of the vehicle 10.

Referring to FIGS. 1 and 2, provided is a driven spring element system 16 (e.g. configured using a pop up mechanism 16a coupled via a cable 16b to a biased cam mechanism 16c), which can be used advantageously with vehicle closure panels 14 to provide for moderating (e.g. in a controlled manner) the initial opening speed of the closure panel 14 of vehicles 10 (i.e. initial opening of the closure panel 14 from the fully closed position—shown in dotted lines in FIG. 2). Further, the closure panel 4 is coupled to a vehicle body 11 via hinges 12 on a pivot axis 18. As such, the closure panel 14 opens about the hinges 12, as driven by the pop up mechanism 16a. The pop up mechanism 16a can include a latch 16d (e.g. a ratchet and pawl type latching system with striker as is known in the art) for retaining the closure panel 14 in the closed position.

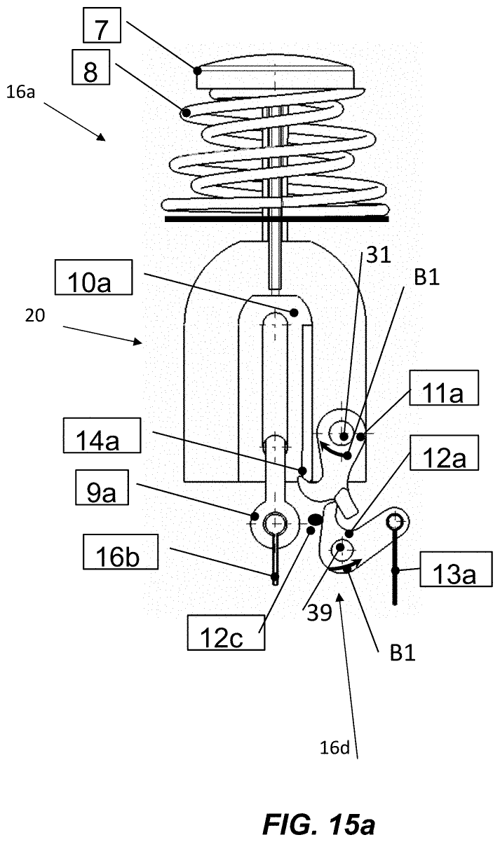

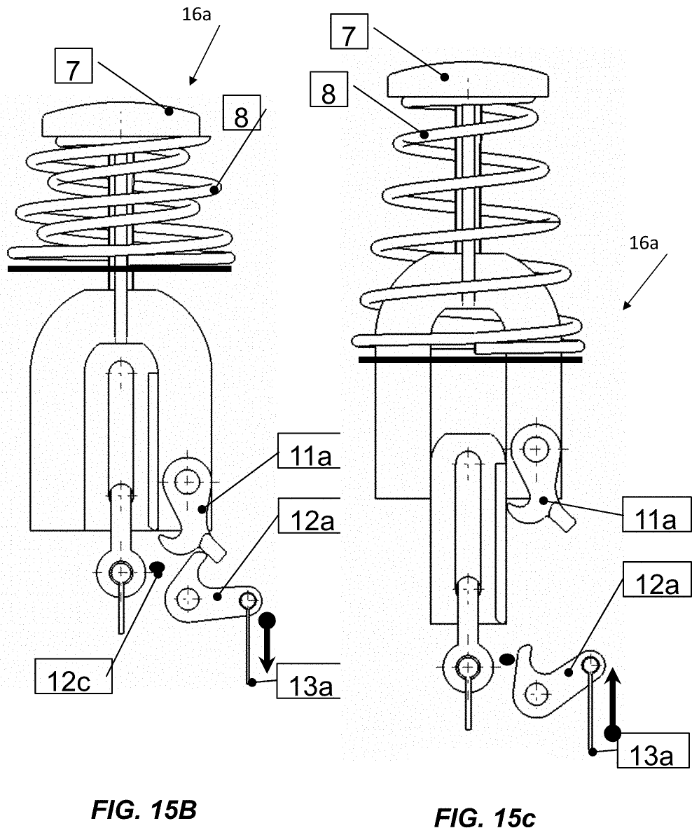

It is recognised that the latch 16d can include a pawl 11a, a lever 12a and an actuator 13a associated with the plunger 7 of the pop up mechanism 16c, as shown in FIG. 15A. The pawl 11a is mounted on a pivot 38 and the lever 12a is mounted on a pivot 39, such that the components 11a, 12a are biased about their respective pivots 38, 39 as shown. The pawl 11a is in position with catch 14a to retain the plunger 7 in an unactuated position as shown (i.e. the plunger 7 is in a home position such that the hood 14 is in the fully closed position). Also shown in FIG. 15A is a damper spring retainer 10a (e.g. mounted on the vehicle body 11), for providing an optional damper resistance to the motion of the plunger 7. Further, shown is a stop 12c for the lever 12a, such that when resting against the stop 39. As shown in FIG. 15B, the actuator 13a is actuated, thus pivoting the lever 12a and thus allowing pivoting of the pawl 11a out of engagement with the stop 12c, which results in the movement of the plunger 7 (as well as the adjacent closure panel 14) under influence of the first biasing element 8 as shown in FIG. 15C .

As further described below, the operation of the pop up mechanism 16a is moderated by the biased cam mechanism 16c, as a plunger 7 (see FIG. 3) forces the closure panel 14 from the closed position to the partially open position. Referring to FIG. 3, the driven spring element system 16 (e.g. configured using the pop up mechanism 16a coupled via the cable 16b to the biased cam mechanism 16c) is shown in a closed position of the closure panel 14. The pop up mechanism 16a has the plunger 7 driven by a first biasing element 8 positioned between the vehicle body 11 and the plunger 7, such that the first biasing element 8 biases the plunger 7 away from the vehicle body 11 and towards the adjacent closure panel 14. Coupled to the plunger 7 can be an optional damper mechanism 20 (e.g. a hydraulic piston—cylinder arrangement used to damp the motion of the plunger 8 away from the vehicle body 11, once released—see FIGS. 15A, 15B, 15C). In any event, once in motion, under influence of the first biasing element 8, the plunger 7 of the pop up mechanism 16a pulls on the cable 16b in order to be influenced by sequenced movement of the biased cam mechanism 16c.

As further described below, since the pop up mechanism 16a is coupled via the cable 16b to the biased cam mechanism 16c, operation of the biased cam mechanism 16c (as coupled to the motion of the plunger 7) will moderate the operation of the pop up mechanism 16a (i.e. the rate at which the plunger 7 travels from the fully closed position (see FIG. 15A) to the partially open position (see FIG. 15C). For example, the speed of the pop up mechanism 16a, which may be controlled by the biasing element 8 or spring, may be slowed down or reduced as compared to an uncontrolled release of spring energy, by providing a resistance against the deployment of energy from the biasing element 8 or spring.

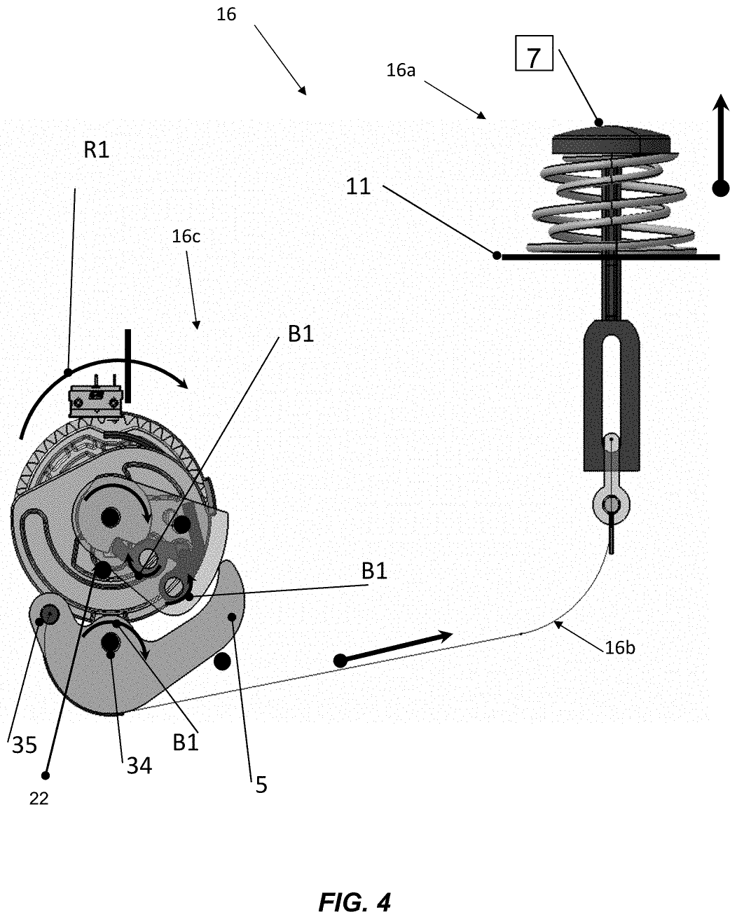

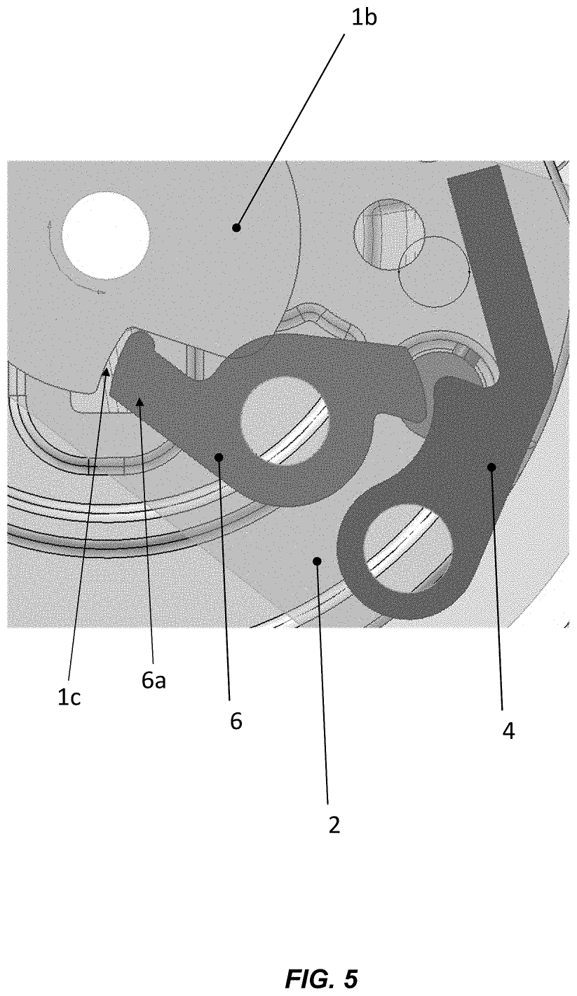

Referring again to FIG. 3, the biased cam mechanism 16c (mounted on the vehicle body 11) can include a drive pulley 1a with control cam 1b mounted on a pivot 30 (of a frame 31), such that the drive pulley 1a can move relative to a cam spring element 2 about the pivot 30. A biasing element is used to bias the drive pulley la with control cam 1b about the pivot 30 as shown. The cam spring element 2 is also mounted on the pivot 30. A control bolt 3 is mounted on the frame 31 (mounted to the vehicle body 11). Further, an engagement lever 4 is mounted on the cam spring element 2 by a pivot 32 and a lifting latch 6 is mounted on the cam spring element 2 by a pivot 33, such that these elements 4,6 are biased as shown in FIG. 4. Also shown in FIG. 4 is a release lever element 5 mounted on pivot 34 (e.g. on the body 11 and/or the frame 31) and coupled to the cable 16b at end 35. As shown, the release lever element 5 is biased about the pivot 34. Also shown is a stop 22 for the cam spring element 2, which resists rotation of the cam spring element 2 about the pivot 30 in a first direction as shown.

A cable spring holder 9a is shown for coupling the cable 16b to the pop up mechanism 16a. As shown in FIG. 3, the biased cam mechanism 16c is shown in a central position while the closure panel 1 is in the fully closed position (see FIG. 2). Further, the engagement lever 4 is resting against the control bolt 3. The cam spring element 2 abuts up against the stop 22, while the engagement lever 4 rests against the control bolt 3.

Referring to FIG. 4, the close panel 14 remains closed however the latch 16d is operated in a first actuation thus providing for release of the drive pulley la which rotates R1 as shown about the pivot 30 in the first direction. It should be noted that the cam spring element 2 does not pivot about the pivot 30 as the components 1a, 1b pivot about the pivot 30. As shown in FIGS. 4,5, movement of the control cam 1b (mounted on the drive pulley 1a) causes engagement with an abutment end 6a of the lifting latch 6 via a notch 1c of the control cam 1b. For example, the release lever spring element 5 has not yet pivoted about pivot 34.

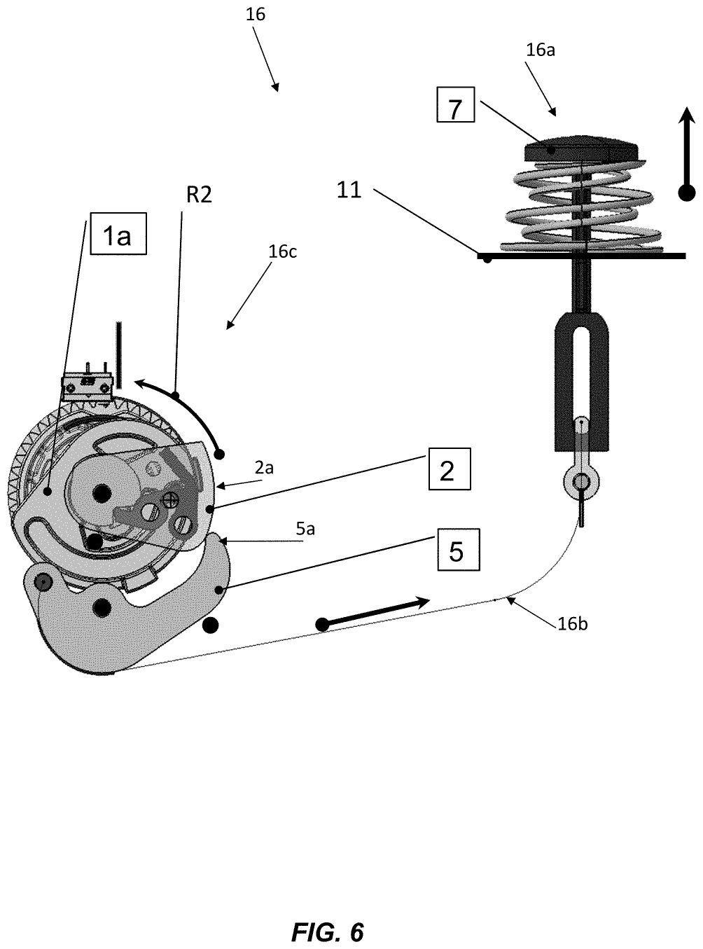

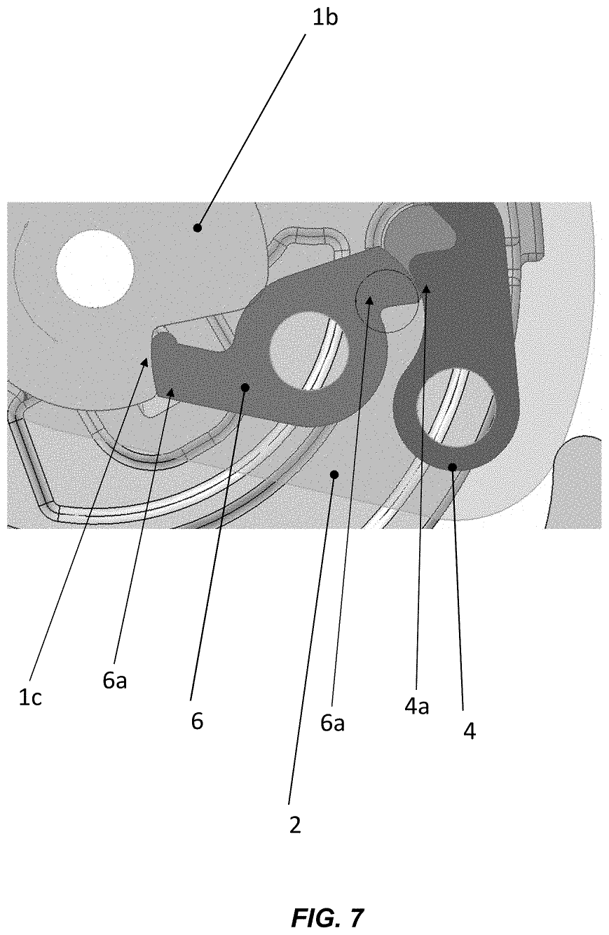

Referring to FIG. 6, shown is a return travel of the drive pulley 1a (and mounted control cam 1b) about the pivot 30, thus the contact between the abutment end 6a and the notch 1c causes the control cam 1b to pick up the cam spring element 2 for conjoint rotation about the pivot 30 in a second direction R2. This movement causes contact between a notch 4a of the engagement lever 4 with an engage end 6d of the lifting latch 6 (see FIG. 7). The engagement lever 4 can come out of contact with the control bolt 3. It should be noted that in FIG. 6, an abutment portion 5a of the release lever spring element 5 is resting against surface 2a of the cam spring element 2, thus can restrain rotation of the release lever spring element 5 about the pivot 34 and thus moderate the movement of the plunger 7. FIG. 6 shows the movement of the control cam 1b CCW by the motor returning to its home position after 1c and 6C have engaged by the motor previously rotating CW the control cam 1b to allow the pawl 6a to lock with the notch 1c. From FIG. 6 eventually the continued rotation of the control cam 1b can guide the spring upwards as abutment portion 5a rides along surface 2a.

Further, it is recognised that shape/contours of the mating surface 2a and abutment portion 5a can be kinematically optimized (for example, like a common contour) and matched with the timing release of the frunk lock (i.e. latch 16d). For example, one may not want to start release (i.e. operation of the biased cam mechanism 16c) until the latch 16d has released, which can add load to the ratchet pawl elements of the latch 16d (e.g. increasing release efforts). According, the cam surface 2a can therefore provide a time delay between a signal (received by the latch 16d either mechanically or electronically) to release the pawl (of the latch 16d—not shown) and the signal to start the actuator (e.g. biased cam mechanism 16c). The pawl of the frunk latch 16d could stay in the open position before the hood (i.e. closure panel 14) is pushed up by the pop up mechanism 16a.

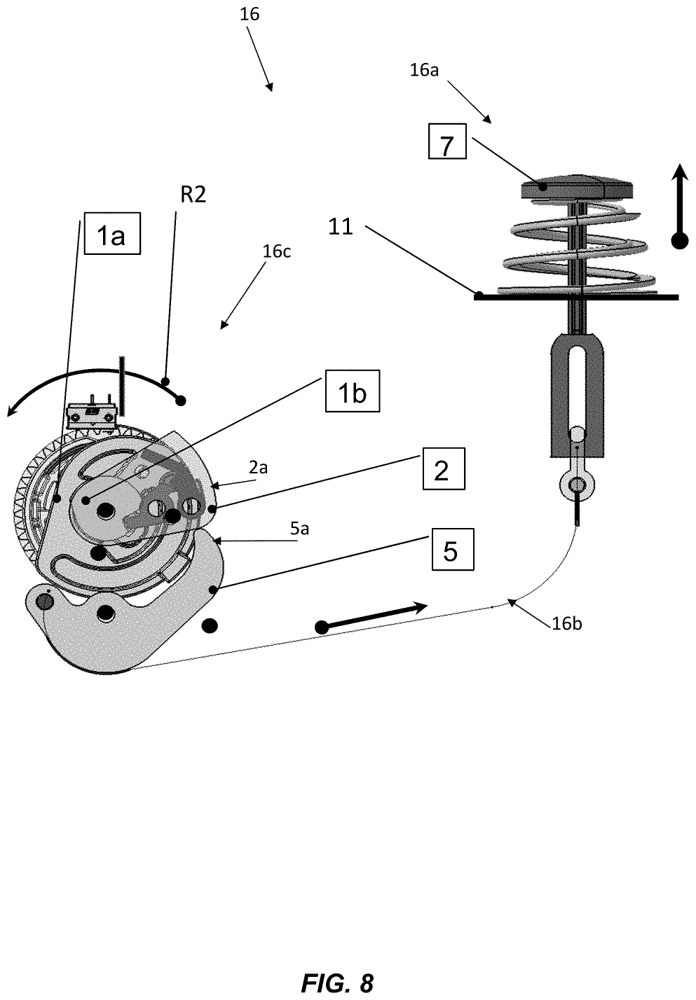

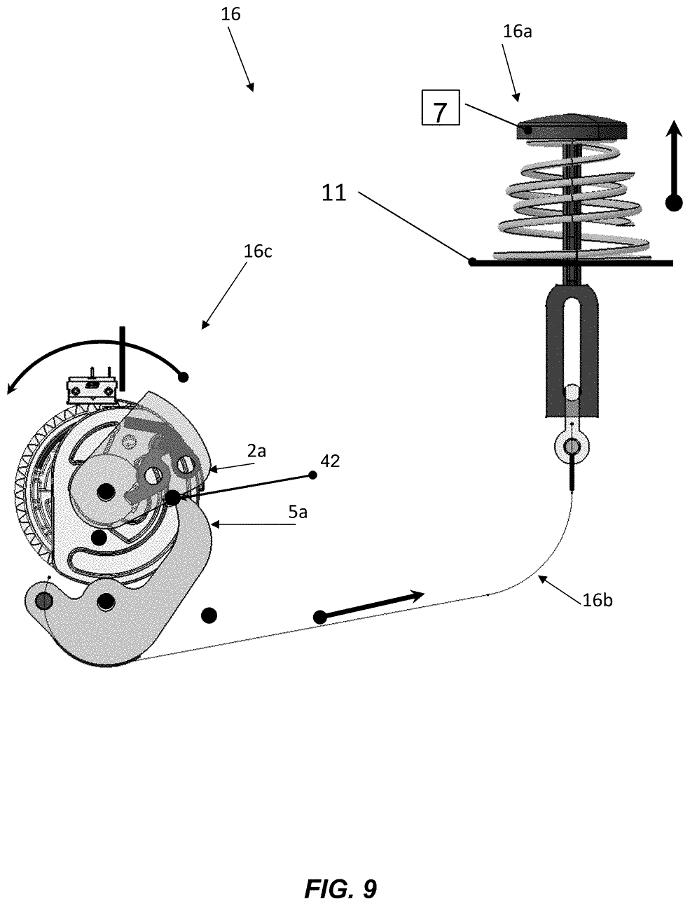

Referring to FIG. 8, as the rotation R2 continues, the abutment portion 5a of the release lever spring element 5 continues to ride against moving surface 2a of the cam spring element 2, and as such the pivot speed (e.g. rate of rotation) of the release lever spring element 5 is moderated (e.g. controlled) by the movement (i.e. rotation R2) of the cam spring element 2. In other words, since the mechanisms 16a, 16c are coupled to one another by the cable 16b, rate of expansion of the first biasing element 8 (and thus movement of the plunger 7 away from the body 11) is dependent (i.e. is proportional to) on how fast (i.e. the rate of rotation) pivoting of the drive pulley 1 a is against its bias (e.g. bias as noted by B1 in FIG. 3). In this manner, the rate of travel of the plunger 7 away from the body 11 can be moderated against the bias B1 of the cam bias mechanism 16c. FIG. 9 shows further rotation of the mechanism 16c about the pivot 30 against the bias B1 over that of FIG. 8, as well as further progression of the plunger 7 away from the body 11. As noted, the abutment portion 5a continues to follow the surface 2a until it encounters a stop 42.

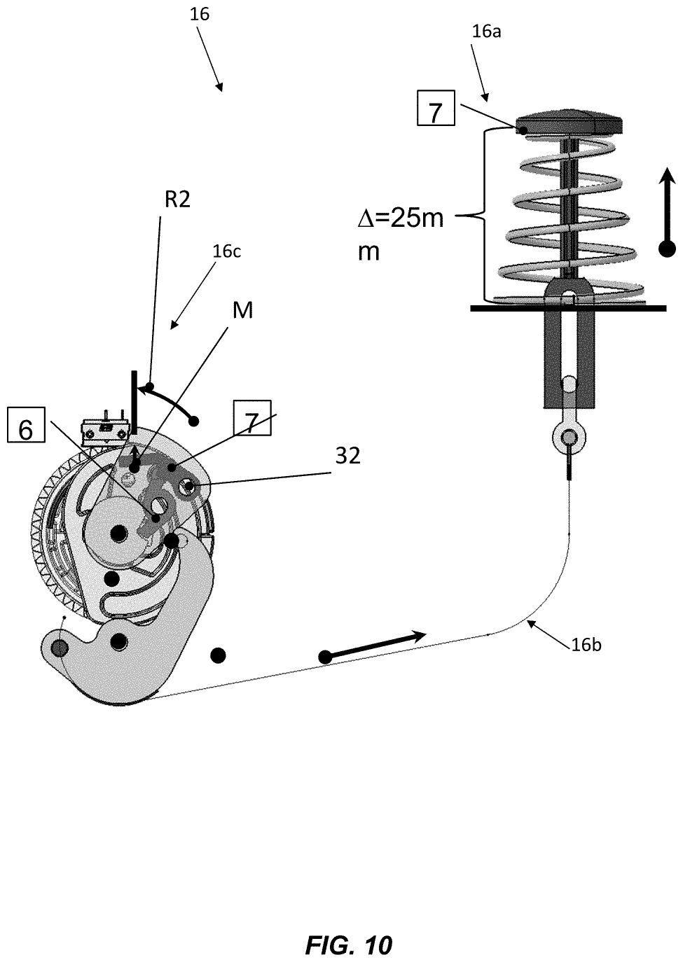

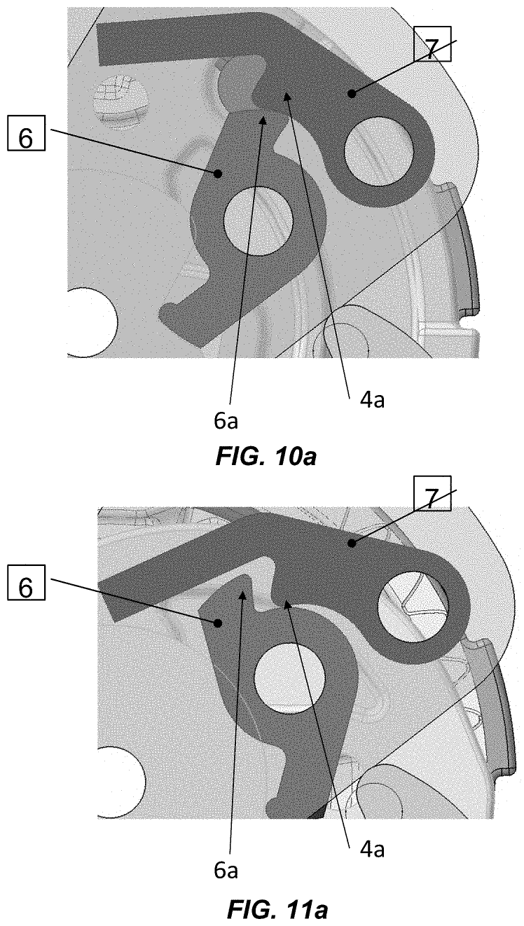

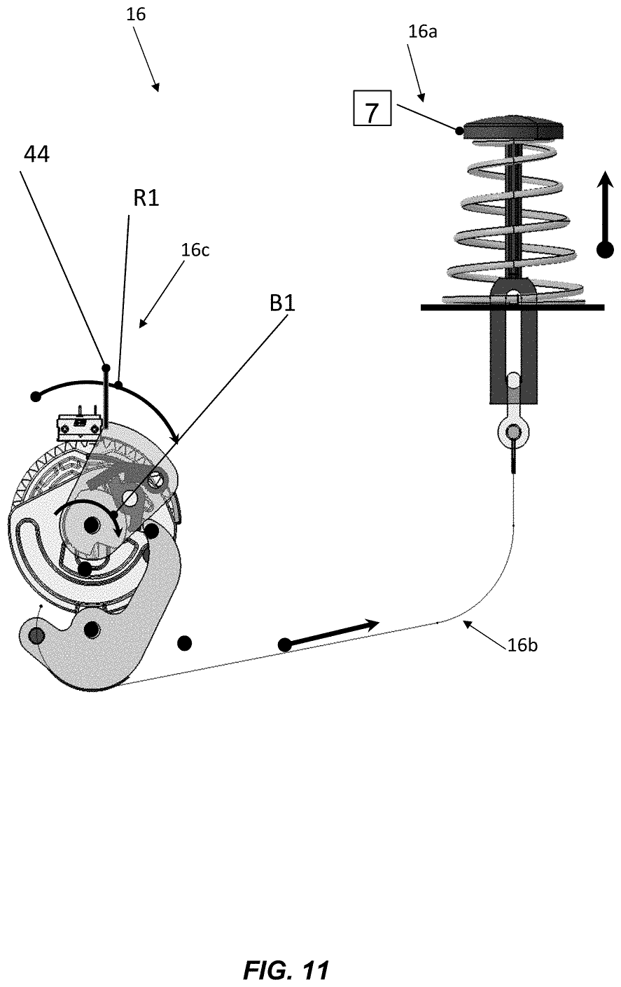

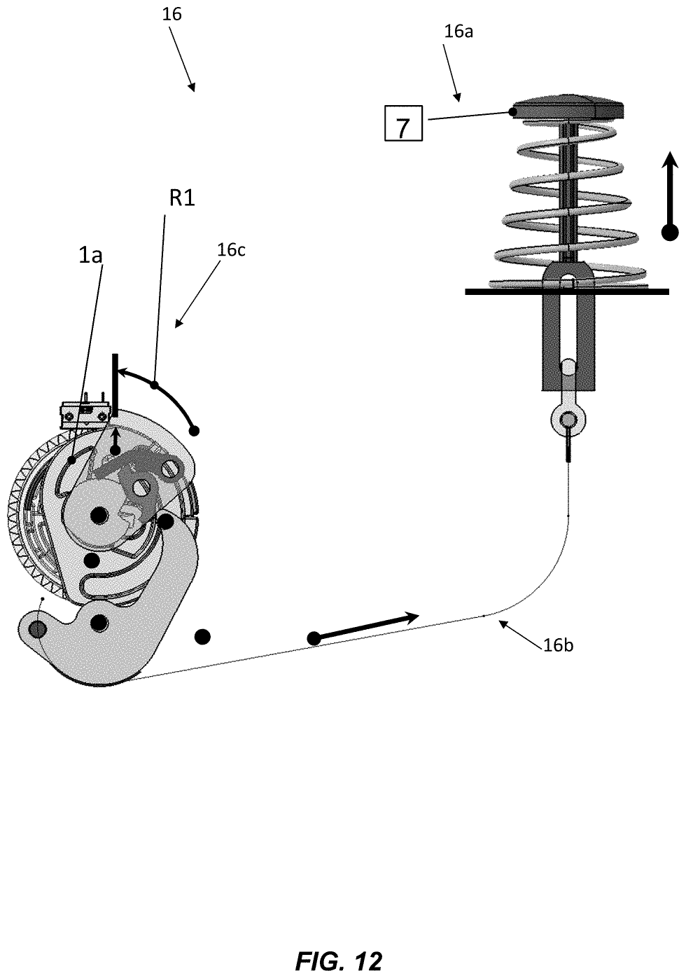

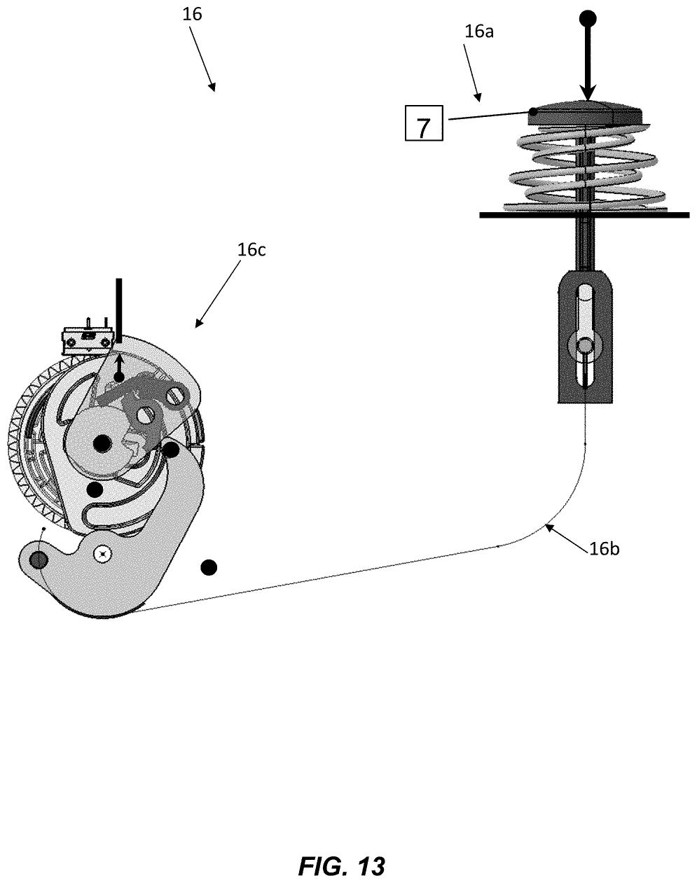

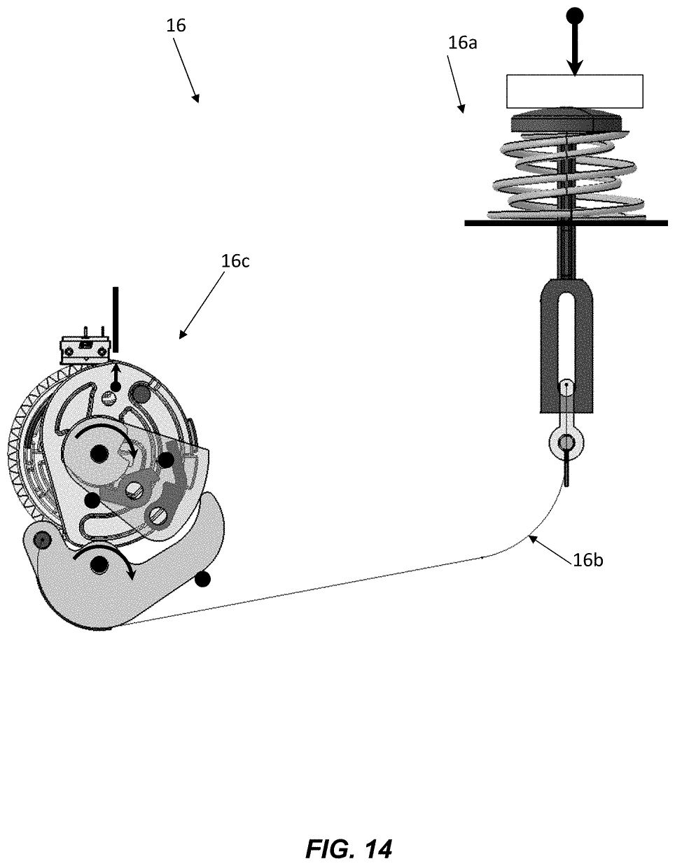

Further rotation R2 in FIG. 10 from that shown in FIG. 9 causes the lifting latch 6 to move M the engagement lever 4 about pivot 32, resulting in decoupling of the lifting latch 6 from the control cam 1b (see FIG. 11). It is noted that cam spring element 2 can also encounter a stop 44. Once the control cam 1b and the lifting latch 6 are disengaged, the drive pulley 1a is free to pivot again back in the first direction R1 under influence of bias B1. FIG. 10a shows the relationship of portion 6a and notch 4a of FIG. 10. FIG. 11 a shows the relationship of portion 6a and notch 4a of FIG. 11. FIG. 12 shows rotation R1 of the drive pulley 1a s a result of the decoupling shown in FIG. 11, along with reengagement of the lifting latch 6 with the engagement lever 4. Once engaged, pushing of the plunger 7 back down (e.g. by pushing on the closure panel 14 back to the closed position shown in FIG. 15A, 2—see FIG. 13) will cause the cable 16b to lose tension and thus facilitate the return of the release lever spring element 5 to the home position (see FIG. 14) and the cam spring element 2 as well. In this way, the system 16 can be reset for another actuation of the latch 16d.

In view of the above, it is advantageous for the spring driven system 16 to moderate an opening speed of the closure panel 14 of the vehicle 10, whereby the system 16 can include: the pop up mechanism 16a mounted adjacent to the closure panel 14 for moving the closure panel 14 from a closed position to a partially open position, the pop up mechanism having a plunger 7; and the biased cam mechanism 16c coupled to the pop up mechanism16a by a coupling 16b, the biased cam mechanism 16c having a biasing element B1 for moderating a deployment rate of the plunger 7. For example, the biased cam mechanism 16c can have a cam spring element 2 coupled to the biasing element B1 (e.g. via the control cam 1b once engaged via the lifting latch 6) and a release lever 5 coupled to the pop up mechanism 16a by the coupling 16b, such movement of the cam spring element 2 is coupled via the release lever 5 to the deployment rate of the plunger 7.

A further advantage for operation of the system 16 is in the use of the biased cam mechanism 16c for coupling by a coupling 16b to a pop up mechanism 16a used by a closure panel 14 of a vehicle 10, the biased cam mechanism 16c having a biasing element B1 for moderating a deployment rate of a plunger 7 of the pop up mechanism 16a by engaging with a cam spring element 2.

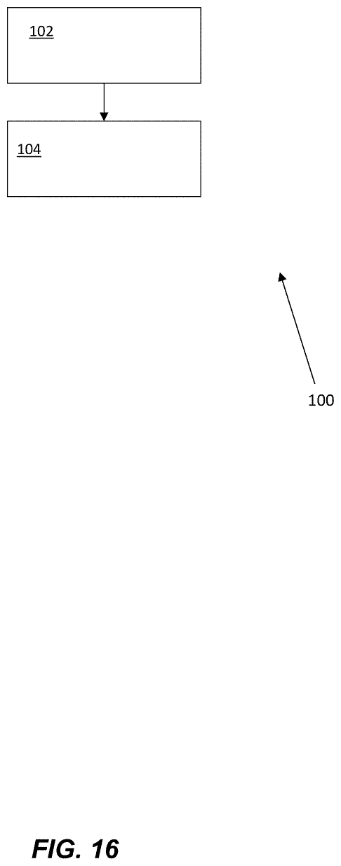

FIG. 16 shows an example method 100 whereby an opening speed of a closure panel 14 of a vehicle 10 is moderated. At step 102 a biased cam mechanism 16c is coupled to the pop up mechanism 16a by a coupling 16b; and at step 104 a biasing element B1 of the biased cam mechanism 16c is engaged to movement of the coupling 16b in order to moderate a deployment rate of a plunger 7 of the pop up mechanism 16a.

Referring to FIG. 1A and 1B, provided is a hinge based detent mechanism 116 (e.g. configured using one or more detent elements 15) that can be used advantageously with vehicle closure panels 14 to provide for open and close operations for the closure panel(s) 14 of vehicles 10. Other applications of the hinge based detent mechanism 116, in general for closure panels 14 both in and outside of vehicle applications, include advantageously assisting in optimization of overall hold and manual effort forces for closure panel 14 operation. It is recognized as well that the hinge based detent mechanism 116 examples provided below can be used advantageously as the sole means of open and close assistance for closure panels 14 or can be used advantageously in combination (e.g. in tandem) with other closure panel 14 biasing members (e.g. spring loaded hinges, biasing struts, etc.). In particular, the hinge based detent mechanism 116 can be used to provide or otherwise assist in a holding force (or torque) for the closure panel 14. Further, it is recognized that the hinge based detent mechanism 16 can be integrated in conjunction with hinges 12 (see FIGS. 1b, 4b) of the closure panel 14 such as a component of a closure panel 14 assembly, as further described below. The hinges 12 can have a panel side portion 112a for connecting the hinge based detent mechanism 116 to the closure panel 14 and a body side portion 12b for connecting the hinge based detent mechanism 116 to a vehicle body 11. The hinge based detent mechanism 116 can advantageously include the detent elements 15 packaged near the hinge (i.e. pivot) axis 18.

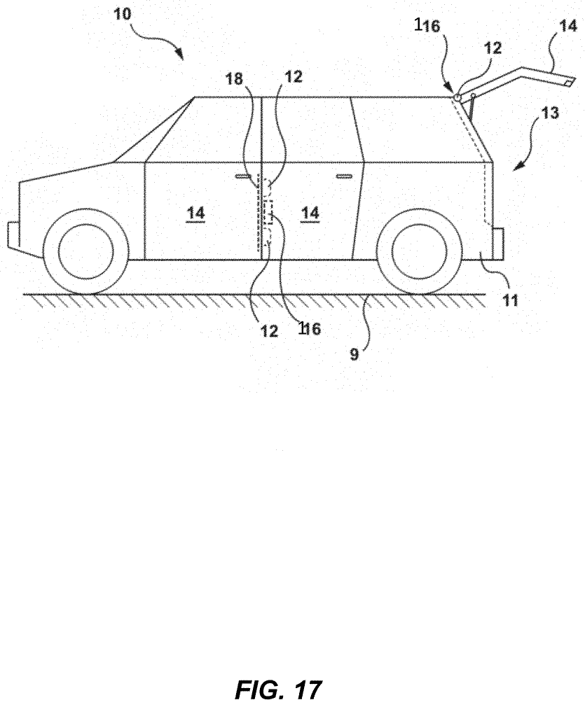

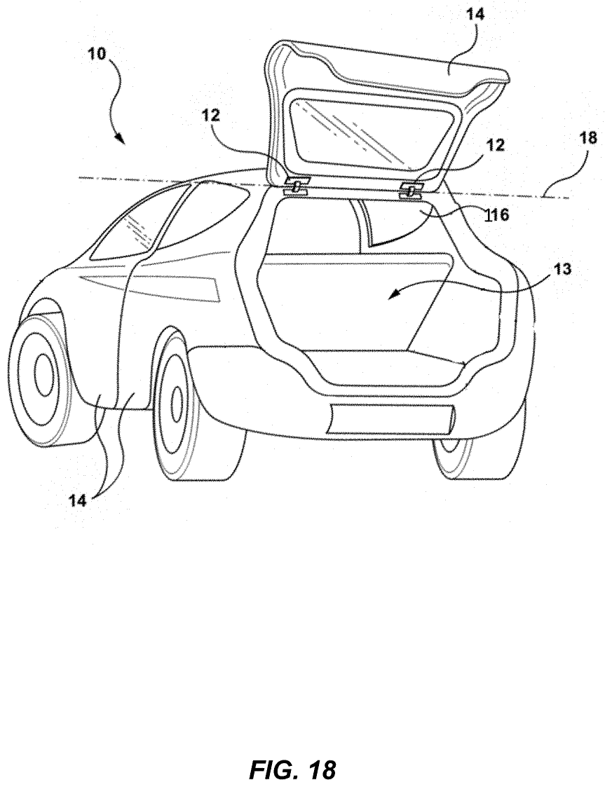

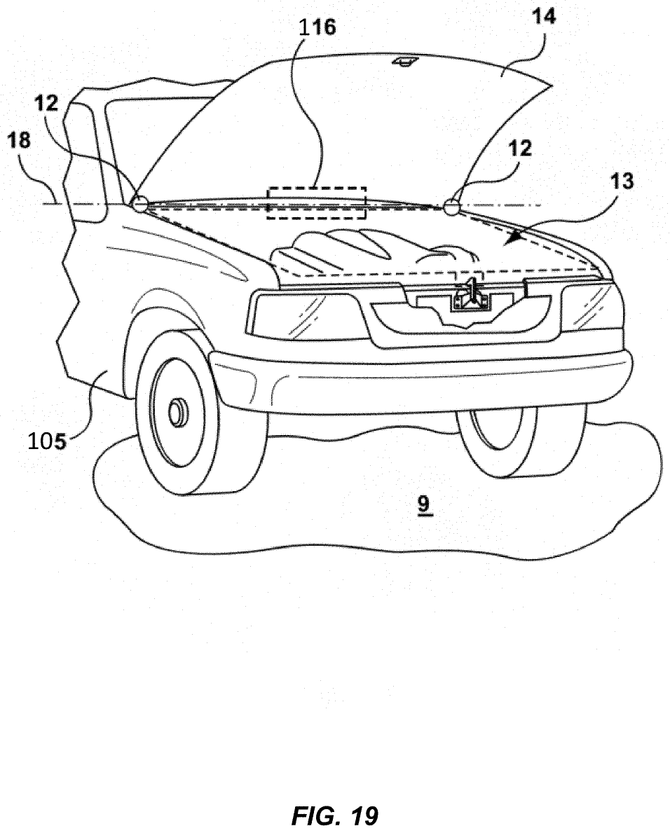

Referring again to FIGS. 17 and 18, shown is the vehicle 10 with a vehicle body 11 having one or more closure panels 14. For vehicles 10, the closure panel 14 can be referred to as a partition or door, typically hinged, but sometimes attached by other mechanisms such as tracks, in front of an opening 13 which is used for entering and exiting the vehicle 10 interior by people (see FIG. 20) and/or cargo. It is also recognized that the closure panel 14 can be used as an access panel for vehicle 10 systems such as engine compartments (see FIG. 19) and also for traditional trunk compartments of automotive type vehicles 10. The closure panel 14 can be opened to provide access to the opening 13, or closed to secure or otherwise restrict access to the opening 13. For example decklids, frunks, hoods, tailgates. Also closure panel 14 can be for a center console with hinged lid configuration, glove compartments, pickup truck covers, windows and the like. It is also recognized that there can be one or more intermediate hold positions of the closure panel 14 between a fully open position and fully closed position, as provided at least in part by the detent element 15. For example, the detent element 15 can assist in biasing movement of the closure panel 14 away from one or more intermediate hold position(s), also known as Third Position Hold(s) (TPHs) or Stop-N-Hold(s), once positioned therein. It is also recognized that the detent element(s) 15 can be provided as a component of the closure panel 14 assembly.

The closure panel 14 can be opened manually and/or powered electronically via the hinge based detent mechanism 116, where powered closure panels 14 can be found on minivans, high-end cars, or sport utility vehicles (SUVs) and the like. Additionally, one characteristic of the closure panel 14 is that due to the weight of materials used in manufacture of the closure panel 14, some form of force assisted open and close mechanism (or mechanisms) are used to facilitate operation of the open and close operation by an operator (e.g. vehicle driver) of the closure panel 14.

In terms of vehicles 10, the closure panel 14 may be a lift gate as shown in FIGS. 17 and 18, or it may be some other kind of closure panel 14, such as an upward-swinging vehicle door (i.e. what is sometimes referred to as a gull-wing door) or a conventional type of door that is hinged at a front-facing or back-facing edge of the door (see FIG. 20), and so allows the door to swing (or slide) away from (or towards) the opening 13 in the body 11 of the vehicle 10. Canopy doors are a type of door that sits on top of the vehicle 10 and lifts up in some way, to provide access for vehicle passengers via the opening 13 (e.g. car canopy, aircraft canopy, etc.). Canopy doors can be connected (e.g. hinged at a defined pivot axis and/or connected for travel along a track) to the body 11 of the vehicle at the front, side or back of the door, as the application permits.

Referring again to FIG. 17, in the context of a vehicle application of a closure panel by example only, the closure panel 14 is movable between a closed position (shown in dashed outline) and an open position (shown in solid outline). In the embodiment shown, the closure panel 14 pivots between the open position and the closed position about a pivot axis 18 (see FIG. 19), which can be configured as horizontal or otherwise parallel to a support surface 9 of the vehicle 10. In other embodiments, the pivot axis 18 may have some other orientation such as vertical (see FIG. 17) or otherwise extending at an angle outwards from the support surface 9 of the vehicle 10.

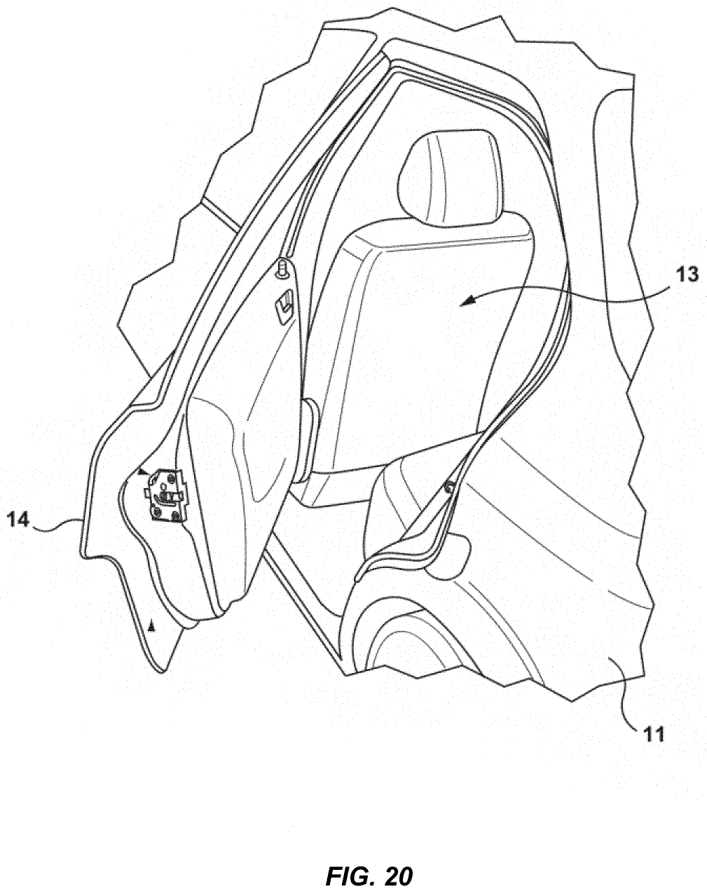

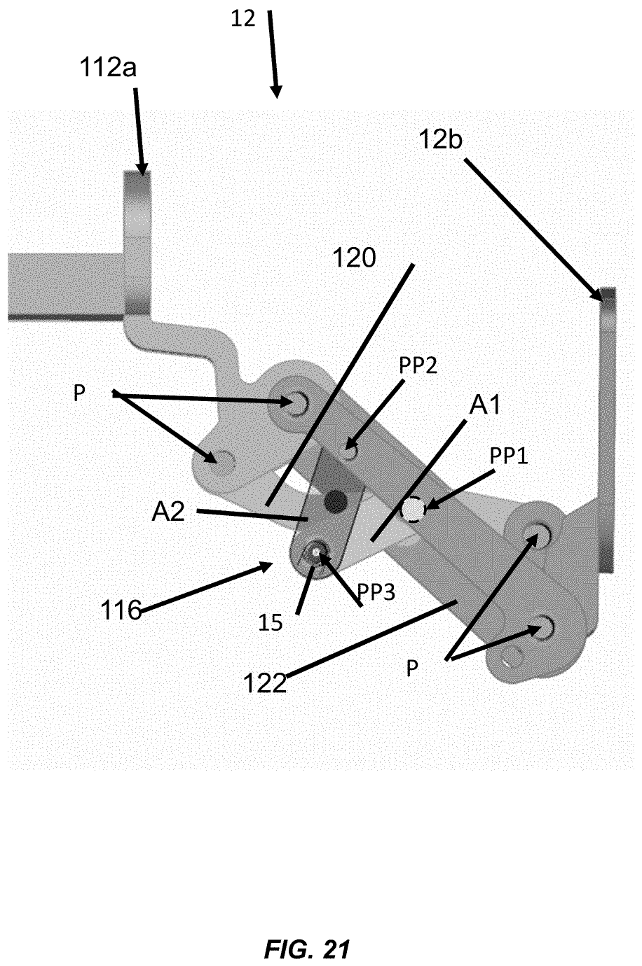

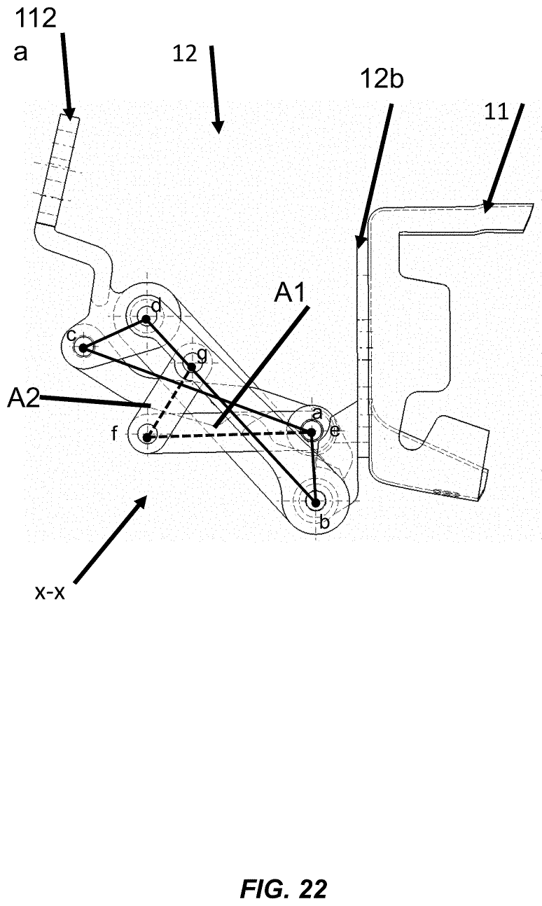

Referring to FIG. 21, shown is an embodiment of the hinge 12, having hinge portion 112a for mounting on the closure panel 14 and hinge portion 12b for mounting on the body 11. Further, the portions 112a, 12b can be connected to one another by a connection rod 120 and a middle element 122, thus providing the hinge 12 as a multi bar linkage (e.g. 4 links x-x by example a-b, a-c, c-d, and b-d—see FIG. 22). Further, each of the links x-x are connected to one another by a respective pivot point, generically denoted by P. In addition, there can be the detent mechanism 116 having a detent element 15 positioned on a pair for detent members (e.g. linkage rods) A1, A2. As such, the detent mechanism 116 is connected to the hinge 12 by a pair of pivots PP1, PP2, with a further pivot PP3 coupling the two detent members A1 ,A2 to one another. As such, each of the pivots PP1, PP2 are located on a respective detent member A1, A2.

Referring to FIG. 22, the detent mechanism 116 can provide two additional linkages a-f, f-g, represented by the two additional linkage elements A1, A2 (e.g. rods).

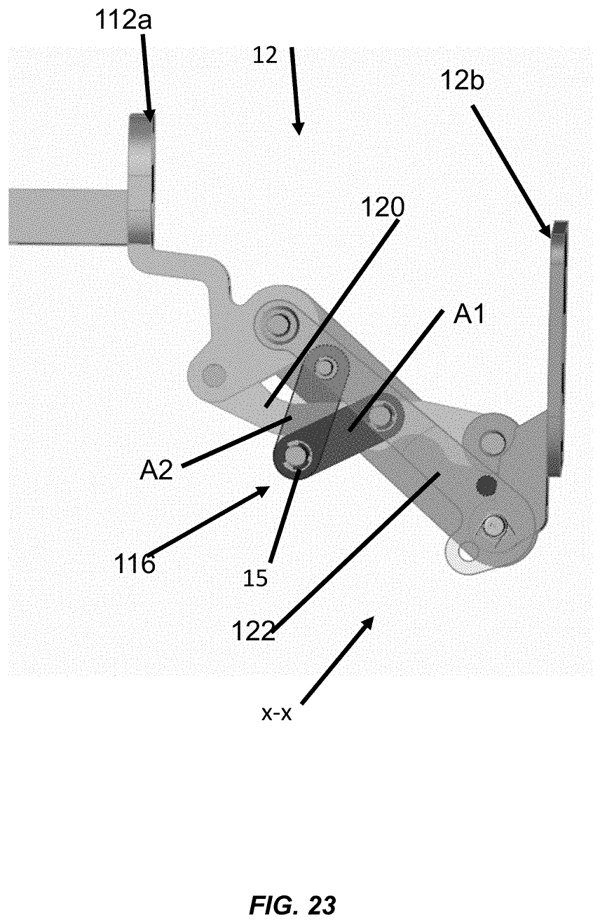

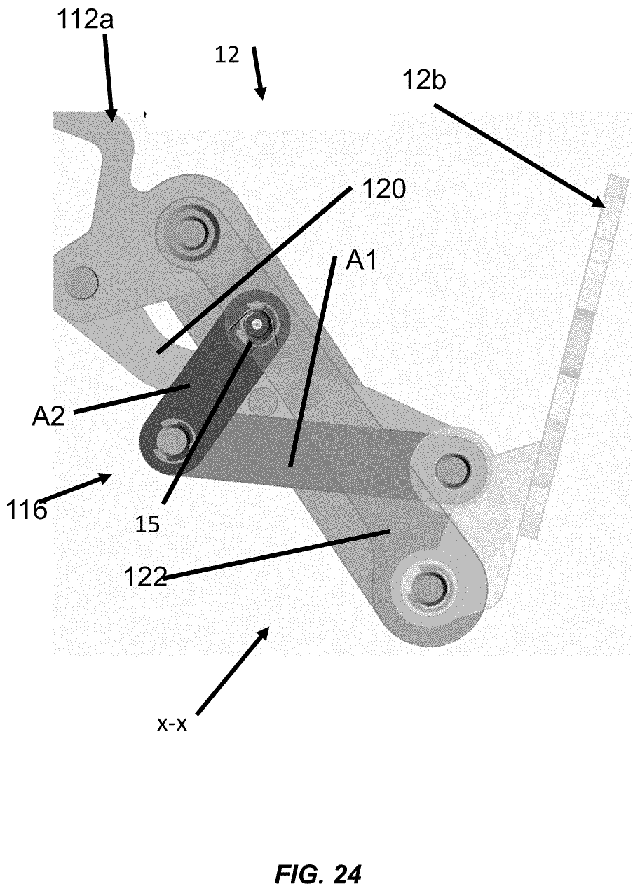

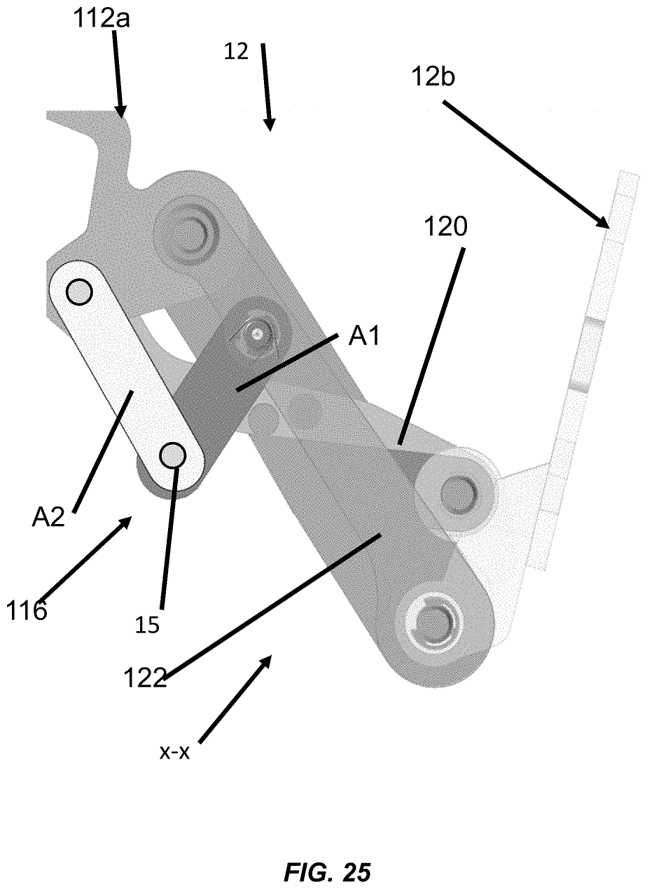

Referring to FIGS. 23-25, shown are embodiments of the hinge 12 with detent mechanism 116, such that different linkages x-x configurations making up the hinge 12 (e.g. linkage a-b, a-c, c-d, and b-d) can be coupled to the detent mechanism 116 by the pivots PP1, PP2, as desired. For example, FIG. 23 shows the additional linkage rods A1, A2 can be connected to the connection rod 120 and the middle element 122. For example, FIG. 24 shows the additional linkage rods A1, A2 can be connected to the body part 12b and the middle element 122. For example, FIG. 25 shows the additional linkage rods A1, A2 can be connected to the door part 112a and the middle element 122. It is also recognised that rather than the middle element 122 of FIGS. 24, 25, instead the pivot PP1, PP2 (see FIG. 21) can be connected to the connection rod 120.

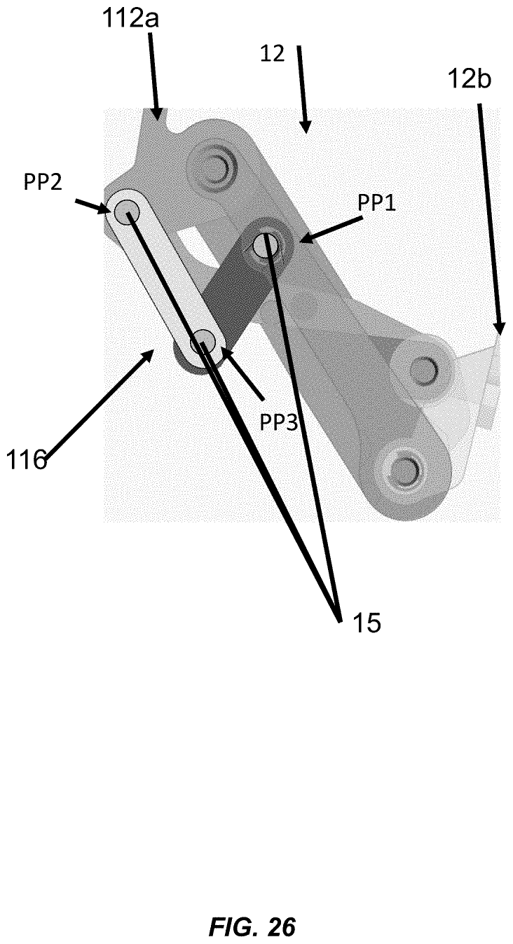

Referring to FIG. 26, the detent element 15 can be positioned at any one or more of the pivots PP1, PP2, PP3, of the detent mechanism 116 as desired. For example, the detent element 15 can be positioned at pivot PP1. For example, the detent element 15 can be positioned at pivot PP2. For example, the detent element 15 can be positioned at pivot PP3. For example, the detent element 15 can be positioned at pivot PP1 and pivot PP2. For example, the detent element 15 can be positioned at pivot PP1 and pivot PP3. For example, the detent element 15 can be positioned at pivot PP3 and pivot PP2. For example, the detent element 15 can be positioned at pivot PP1, PP3 and pivot PP2.

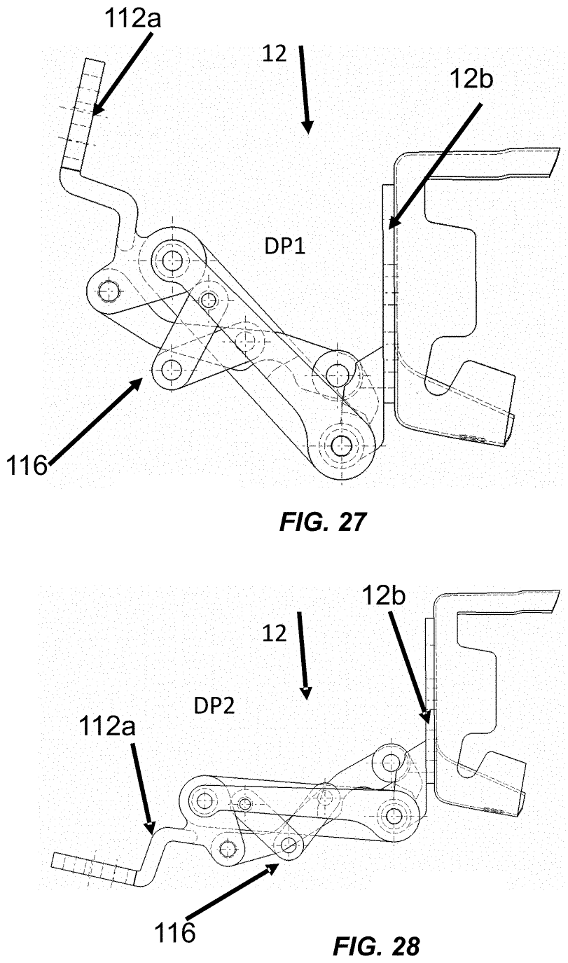

As such, by use of the pivots PP1, PP2, the detent mechanism 116 (with associated detent element 15) can be connected to the linkages x-x of the hinge 12 itself. Referring to FIGS. 27, 28, shown are different operational positions of the detent mechanism 116 coupled to the hinge 12 (e.g. FIG. 27 shows a first detent position DP1 and FIG. 28 shows a second detent position DP2.

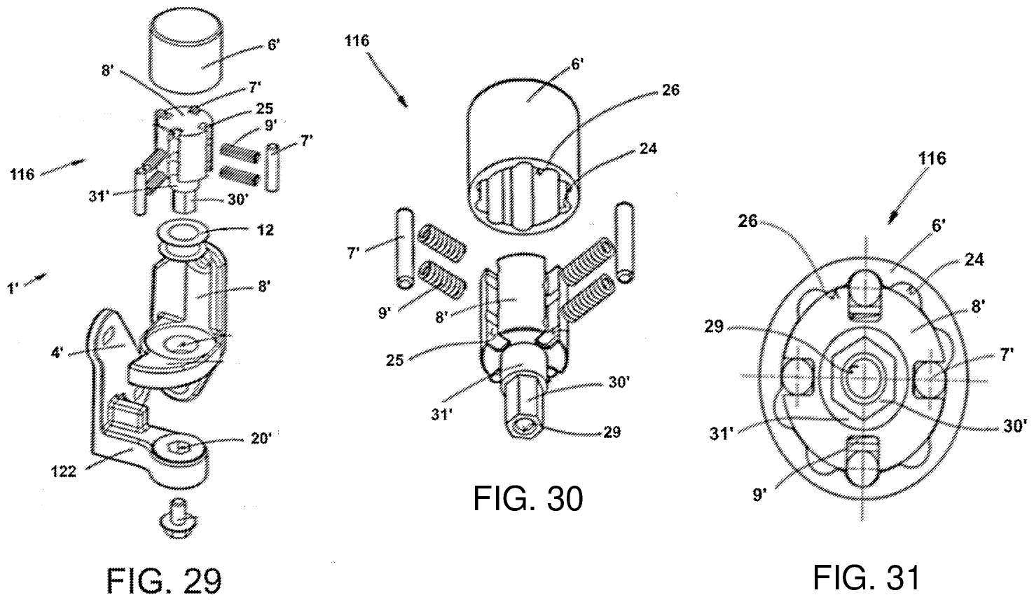

FIG. 29 shows a further embodiment of a detent element 15 of FIG. 21. FIG. 30 is an exploded view of the detent element 15 of FIG. 29. FIG. 31 is a sectional view through the detent element 15 of the door hinge 12 of FIG. 29. A body support (e.g. locking body carrier) 8′ of the detent element 15 can be formed in one piece and can have a shaft 31′ to be inserted in its rotatable arrangement in the pivot PP1, PP2, PP3 (e.g. a bearing sleeve). The shaft 31′ can have a hexagonal connecting section 30′, which can be arranged in a correspondingly corresponding receiving opening of the pivot PP1, PP2, PP3, such that the detent element 15 can be secured in the pivot PP1, PP2, PP3 by a fastener (not shown) screwed into a threaded bore 29. The locking body carrier 8′ can be circular in cross section and has grooves 25 arranged at 90° angles on the circumferential surface. The grooves 25 serve to receive pins 7′, which are spring-loaded radially away by coil springs 9′ resting against ends of opposite pins 7′. The spiral springs 9′ are arranged in corresponding bores 13′ on the locking body support 8′.

In the assembled state, a locking sleeve 6′ is arranged coaxially to the locking body carrier 8′ with the pins 7′ arranged thereon. On an inner surface 26 of the locking sleeve 6′, corresponding locking positions 24 of the motor vehicle door 14 are arranged in corresponding opening positions (i.e. predefined hold positions).

In a locked angular position of the motor vehicle door 14, the pins 7′ are arranged completely in the grooves 25 and are prestressed by the spiral springs 9′. When a corresponding angular position is reached, the pins 7′ are partially pressed out of the grooves 25 into the detent marks 24 by the spiral springs 9′, as a result of which the respective angular position is locked. Further, the locking sleeve 6′ is attached/fixed to one of the additional arms A1, A2 and the locking body carrier 8′ is attached/fixed to the other of the additional arms A1, A2, such that the locking sleeve 6′ and the locking body carrier 8′ rotate relative to one another about a pivot axis 27 as the additional arms A1, A2 pivot about their pivot points PP1, P2, PP3 as the hinge 12 is operated between the open and closed position of the closure panel 14. In this manner, the pins 7′ move from their current groove 25 to an adjacent unoccupied groove 25, thus moving from one predefined hold position to the next predefined hold position.

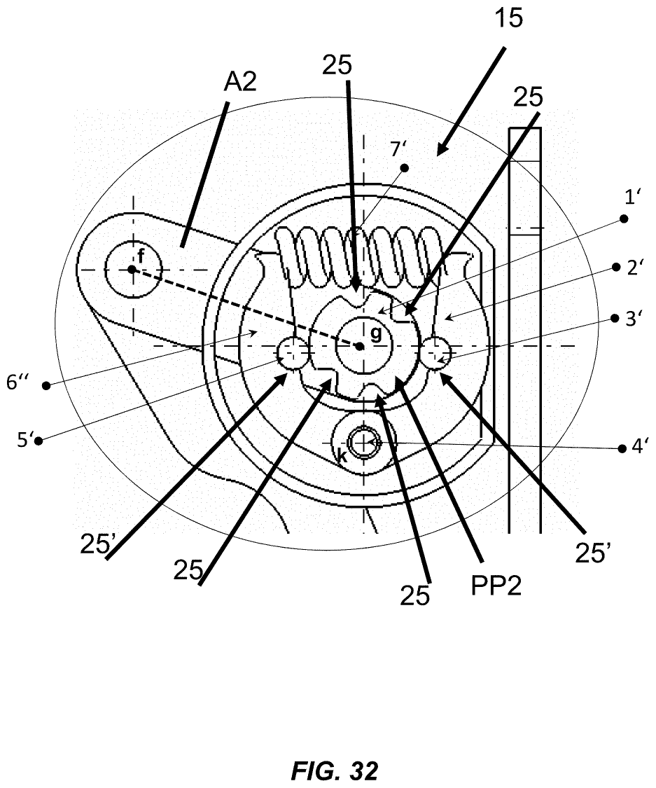

Referring to FIG. 32, a further embodiment of the detent element 15 is shown by example coupled to pivot PP2 of the detent mechanism 116 (e.g. coupled between the additional arm A2 and the middle element 122—see FIGS. 4,5,21,22). The detent element 15 can include a rotary camshaft 1′ having grooves 25, a locking lever 2′, a roller (e.g. cylinder) 3′, a rotation axis 4′ of lever 2′ and a locking lever 6′, a further roller 5′, the locking lever 6′, and a tension spring 7′. The tension spring 7′ biases one end (opposite the rotation axis 4′) of the levers 2′, 6″ towards each other, in order to keep the rollers 3′,5′ seated in a corresponding receptacle 25′ of the levers 2′, 6″.

As such, the levers 2′,6″ (e.g. via a pin connecting the rotation axis 4′) can be fixed to the middle element 122 (or other linkage x-x as desired). Further, the rotary camshaft 1′ can be connected/fixed to the other linkage x-x of the pivot PP2, i.e. the additional arm A2, adjacent the pivot PP2. As such, the rotary camshaft 1′ and the set of locking levers 2′, 6″ rotate relative to one another (as the levers 2′, 6″ move relative to one another about the pivot axis 4′) as the additional arms A1, A2 pivot about their pivot points PP1, P2, PP3, as the hinge 12 is operated between the open and closed position of the closure panel 14 (see FIG. 1,17,18). In this manner, the pins 3′,5′ move from their current groove 25 to an adjacent unoccupied groove 25 in the rotary camshaft 1′, thus moving from one predefined hold position to the next predefined hold position.

In view of the above, the detenting angle of the closure panel 14 with respect to the body 11 of the vehicle 10 can be set by the spacing between the grooves 25 about the inner surface 26 of the rotary cam 1′ and/or the locking sleeve 6′. As such, the detent mechanism 15 can be located in the detent mechanism 116, in any/all of the pivot point(s) PP1, PP2, PP3, as desired. Accordingly, the additional rods A1, A2 move together with the hinge 12 in case of the door 14 being opened. Due to the additional linking points PP1,PP2, PP3 between the new linkage rods A1, A2 and the hinge linkages 112a, 12b, 120, 122, there are new options for positioning the detent element 15.

An example operation for positioning a closure panel 14 of a vehicle 10 at a predefined detent position between an open position and a closed position of the closure panel 14. The method can comprise the steps of: providing a plurality the linkages x-x connecting the closure panel 14 to the vehicle body 11 for guiding movement of the closure panel 14 relative to the vehicle body 11 between the open position and the closed position; and operating the detent mechanism 116 connected to a pair of the plurality of linkages x-x for resisting motion of the hinge 12 during operation of the hinge 12, the detent mechanism including a detent element 15 for providing said resisting motion.

We claim:

1. A spring driven system (16) for moderating an opening speed of a closure panel (14) of a vehicle (10), the system comprising:
a pop up mechanism (16a) mounted adjacent to the closure panel for moving the closure panel from a fully closed position to a partially open position, the pop up mechanism having a plunger; and
a biased cam mechanism (16c) coupled to the pop up mechanism by a coupling (16b), the biased cam mechanism having a biasing element (B1) for moderating a deployment rate of the plunger.

2. The system of claim 1, wherein the biased cam mechanism further comprising a cam spring element (2) coupled to the biasing element and a release lever coupled to the pop up mechanism by the coupling, such movement of the cam spring element is coupled via the release lever to the deployment rate of the plunger.

3. The system of claim 2, further comprising the cam spring element having a cam (2a) surface in contact with an abutment portion (5a) of the release lever.

4. The system of claim 2 further comprising a drive pulley (1a) with a control cam (1b), such that movement of the control cam in a second direction (R2) causes conjoint movement of the cam spring element against the biasing element.

5. The system of claim 4, wherein movement of the control cam in a first direction (R1) is performed relative to a position of the cam spring element.

6. The system of claim 2 further comprising a lifting latch (6) for coupling the control cam to the cam spring element.

7. The system of claim 4, wherein the cam spring element and the drive pulley are mounted to a frame (31) on a pivot (30), such that the drive pulley and the cam spring element rotate about the pivot during operation of the system.

8. The system of claim 1, wherein the coupling is a cable (16b).

9. A biased cam mechanism (16c) for coupling by a coupling to a pop up mechanism used by a closure panel of a vehicle, the biased cam mechanism having a biasing element for moderating a deployment rate of a plunger of the pop up mechanism by engaging with a cam spring element.

10. A method for moderating an opening speed of a closure panel (14) of a vehicle (10) employing a pop up mechanism, the method comprising the steps of:
coupling an actuator coupled to the pop up mechanism by a coupling; and
operating the actuator in order to moderate a deployment rate of the pop up mechanism.

11. The mechanism of claim 9, engaging a biasing element (B1) of the biased cam mechanism to the movement of the coupling in order to moderate a deployment rate of the plunger;
wherein the biased cam mechanism further comprising the cam spring element coupled to the biasing element and a release lever coupled to the pop up mechanism by the coupling, such movement of the cam spring element is coupled via the release lever to the deployment rate of the plunger.

12. The mechanism of claim 11, further comprising the cam spring element having a cam surface in contact with an abutment portion of the release lever.

13. The mechanism of claim 11 further comprising a drive pulley with a control cam such that movement of the control cam in a second direction causes conjoint movement of the cam spring element against the biasing element.

14. The mechanism of claim 13, wherein movement of the control cam in a first direction (R1) is performed relative to a position of the cam spring element.

15. The mechanism of claim 11 further comprising a lifting latch for coupling the control cam to the cam spring element.

16. The mechanism of claim 13, wherein the cam spring element and the drive pulley are mounted to a frame on a pivot, such that the drive pulley and the cam spring element rotate about the pivot during operation of the system.

17. The mechanism of claim 9, wherein the coupling is a cable.

18. A spring driven system (16) for opening a closure panel (14) of a vehicle (10), the system comprising:
a pop up mechanism (16a) mounted adjacent to the closure panel for moving the closure panel from a closed position to a partially open position, the pop up mechanism comprising a spring for biasing the closure panel towards a partially open position; and
an actuator coupled to the popup mechanism for controlling the bias as the closure panel moves towards the partially open position.

19. A system for opening a closure panel (14) of a vehicle (10), the system comprising:
a latch for retaining the closure panel in a closed position and for releasing the closure panel to allow the closure panel to move towards an open position;
a spring for storing energy in a compressed state and for releasing the stored energy during a decompression state, wherein during the decompression state the spring cause the closure panel to move towards a partially open position from the closed position; and
an actuator operably coupled to the spring for reducing the rate of release of the stored energy during the decompression state of the spring subsequent to the latch releasing the closure panel.

20. A biasing arrangement for a hood of a vehicle (10), the system comprising:
a spring positioned between a body of the vehicle and the hood, the spring having a loaded position corresponding to the hood in a closed position and an unloaded position corresponding to the hood in a partially opened position, wherein the spring moving from the loaded position to the unloaded position causes the hood to move from the closed position to the partially opened position; and
an actuator operably coupled to the spring for reducing the rate motion of the spring moving from the loaded position to the unloaded position to control the rate of motion of the hood moving from the closed position to the partially opened position.
